(19) United States
(12) Patent Application Publication
(10) Pub. No.: US 2009/0217379 A1
(43) Pub. Date: Aug. 27, 2009

(54) METHOD FOR ANTIVIRUS PROTECTION AND ELECTRONIC DEVICE WITH ANTIVIRUS PROTECTION

(75) Inventors: Chun-Yen Chang, Taipei City (TW); Jing-Rung Wang, Taipei City (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., Taipei City (TW)

(21) Appl. No.: 12/336,455

(22) Filed: Dec. 16, 2008

(30) Foreign Application Priority Data
Feb. 27, 2008 (TW) TW97106794

(51) Int. Cl. G06F 21/22

(52) U.S. Cl. 726/24

(57) ABSTRACT

The invention provides a method for antivirus protection adapted for an electronic device. First, an option read only memory (ROM) is initialized. Second, all network connection ports of the electronic device are disabled. A first network connection port is enabled to connect the electronic device with an external system. Whether first antivirus software is installed on the electronic device is checked. If it is checked that the first antivirus software is not installed on the electronic device, after second antivirus software is received by the electronic device from the external system via the first network connection port and is installed on the electronic device, the electronic device enables all the network connection ports to connect the electronic device with the external system.

### BACKGROUND OF THE INVENTION

1. Field of the Invention

The invention relates to a method for antivirus protection and an electronic device and, more particularly, to a method for antivirus protection and an electronic device installed with antivirus software by external online.

2. Description of the Related Art

After a user installs an operating system on a computer, without being installed with antivirus software in the beginning, the computer is easy to be infected by a virus. Moreover, the usage of the wireless network is developed at present, and then the computer is immediately under a network circumstance. Therefore, the computer without the antivirus software has a high chance of virus infection. Even if the user installs the antivirus software at once at that moment, in an online state, the computer may be inflected by a virus before the antivirus software is installed. Therefore, even if the antivirus software is installed, the antivirus effect cannot be achieved.

### BRIEF SUMMARY OF THE INVENTION

The invention provides a method for antivirus protection and an electronic device with antivirus protection.

The invention provides a method for antivirus protection adapted for an electronic device. The method includes the following steps. An option read only memory (ROM) is initialized. All network connection ports of the electronic device are disabled. A first network connection port is enabled to connect the electronic device with an external system. Whether first antivirus software is installed on the electronic device is checked. If the first antivirus software is installed on the electronic device, second antivirus software is received and installed on the electronic device via the first network connection port.

The invention provides an electronic device for downloading second antivirus software of an external system in another embodiment. The electronic device includes a basic input output system (BIOS) having an option ROM storing an executable file, a chipset connected with the BIOS, a network module connected with the chipset, and a CPU connected with the chipset. The network module has a plurality of network connection ports. The CPU is used to execute the executable file to disable the network connection ports and enable a first network connection port of the network connection ports to connect the electronic device with the external system. When it is checked that first antivirus software is not installed on the electronic device, the second antivirus software is received and installed via the first network connection port.

Since all the network connection ports (except the predetermined first network connection port) are disabled, the risk of being infected by a virus under a network circumstance after booting process is greatly reduced.

### BRIEF DESCRIPTION OF THE DRAWINGS

FIG. 1 is a flowchart of a method for antivirus protection of a computer according to an embodiment of the invention;

FIG. 2 is a schematic diagram of a personal computer with antivirus protection according to an embodiment of the invention;

FIG. 3 is a flowchart of a method for antivirus protection of a computer according to another embodiment of the invention; and

FIG. 4 is a schematic diagram of a system with antivirus protection of a computer according to an embodiment of the invention.

### DETAILED DESCRIPTION OF THE EMBODIMENTS

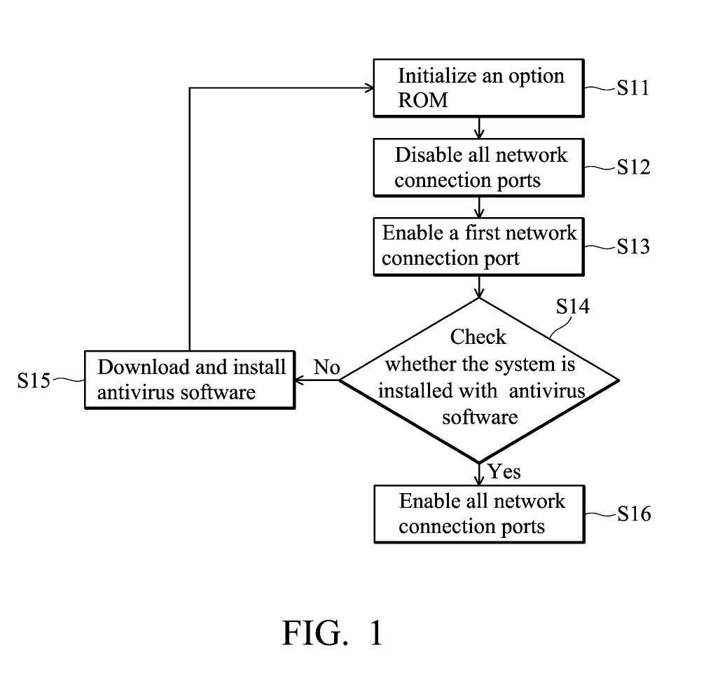

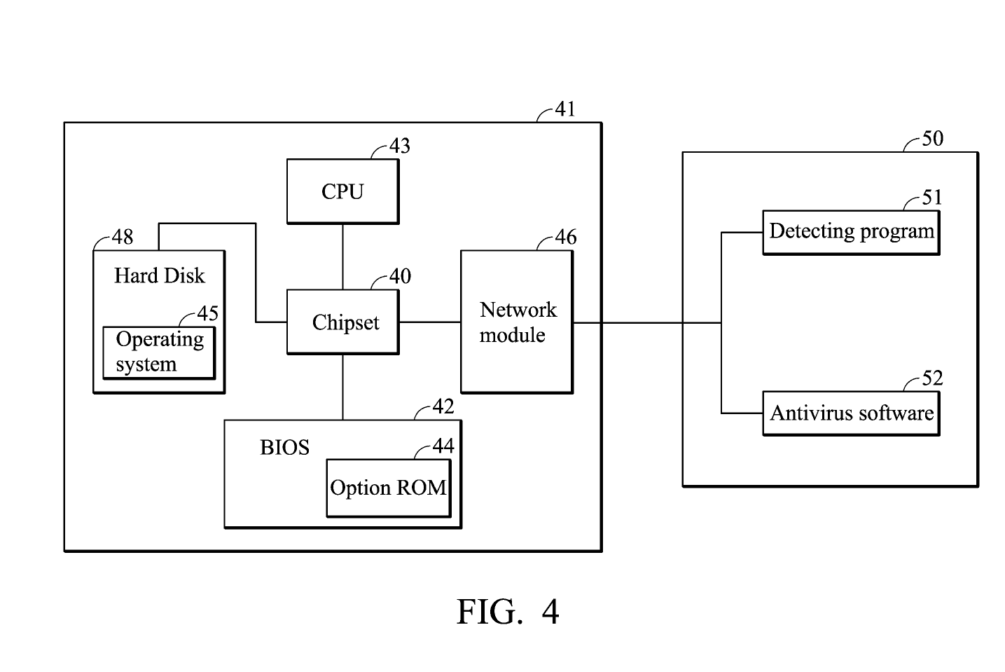

FIG. 1 is a flowchart of a method for antivirus protection of a computer according to an embodiment of the invention. When a computer (or an electronic device) is booted up, a basic input output system (BIOS) is executed and a BIOS power-on self test (POST) is performed first. After the BIOS POST is performed, step S11 is performed. That is, an option read only memory (ROM) in the BIOS is initialized. The option ROM stores an executable file (or an executable program). In step S12, a central processing unit (CPU) of the computer executes the executable file of the option ROM to disable all network connection ports of the computer. Then, a predetermined first network connection port is enabled to connect the electronic device with the network and contact an external system, as stated in step S13. Afterwards, in step S14, a detecting program of the external system (as shown in FIG. 4) is downloaded via the first network connection port to check whether any antivirus software is installed on the computer. If first antivirus software is installed on the computer, step S16 is performed. That is, all the network connection ports are enabled. If no antivirus software is installed on the computer, step S15 is performed. That is, the computer receives second antivirus software via the first network connection port and is installed with the second antivirus software. The second antivirus software may have the same data with the first antivirus software, and it also may be an update edition of the first antivirus software. Since the viruses may increase at any time, in step S14, a user may check whether any antivirus software is installed on the computer and may adjust whether newest updating antivirus software is needed according to a practical situation (for example, whether the software is the newest antivirus software edition).

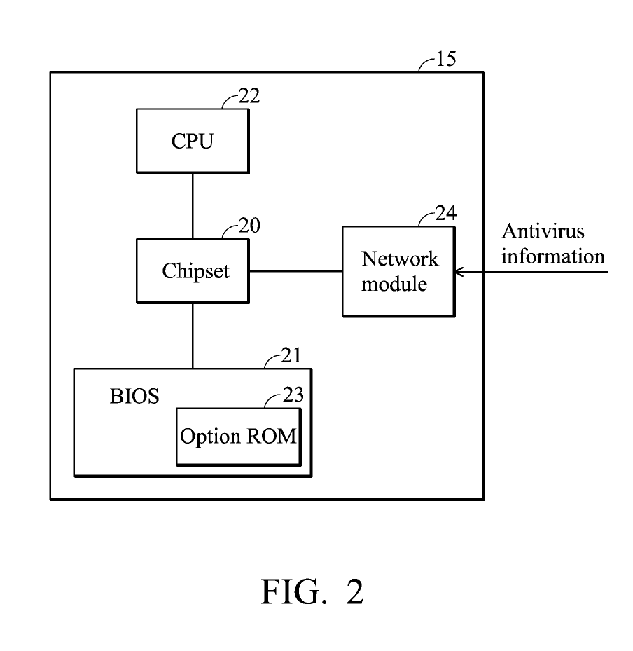

FIG. 2 is a schematic diagram of a personal computer with antivirus protection according to an embodiment of the invention. The personal computer 15 (or an electronic device) includes a chipset 20, a BIOS 21, a CPU 22, and a network module 24. The BIOS 21 is a basic software program loaded in the computer system, and the main functions of the BIOS include performing a POST, initializing hardware, recording basic record values of computer components, and loading an operating system. Since a computer is often infected by viruses before the computer loads antivirus software, in the embodiment of the invention, the computer is under a safe circumstance and away from other unrelated networks before the antivirus software is installed on the computer, and it only enables specific network connection port to download related testing programs or antivirus software. After the computer is booted up, the CPU 22 first executes the BIOS 21 and initializes the option ROM 23 in the BIOS after performing the BIOS POST. After initializing the option ROM 23, the CPU 22 executes an executable file of the option ROM 23 to make the chipset 20 disable all network connection ports of the network module 24 and keep only a predetermined first network connection port enabled to connect the computer with an external system. The external system may be a platform provided by an antivirus software manufacturer. The platform is, for example, a server used to provide related antivirus software or other programs for users or enterprises to download. Furthermore, in the embodiment, the network module 24 may be realized by an Ethernet module or a wireless network module.

Since the network connection ports (except the predetermined first network connection port) are all disabled, the risk of being inflected by a virus under a network circumstance is greatly reduced, and data transferred to the computer via the first network connection port may be monitored by other certification mechanisms to enhance the safety of the computer. Then, the CPU 22 receives antivirus information via the first network connection port. The antivirus information includes a detecting program and other installation programs. The CPU 22 may execute the detecting program to detect whether any antivirus software is installed on the operating system of the computer. If it is detected that the antivirus software is installed on the operating system of the computer, the CPU 22 enables all the disabled network connection ports by chipset 20. If it is detected that the antivirus software is not installed on the operating system of the computer, the CPU 22 executes installation programs. For example, the CPU 22 receives an antivirus program via the predetermined first network connection port and the antivirus program is installed. After the antivirus program is installed, the computer is rebooted and the above actions are performed repeatedly.

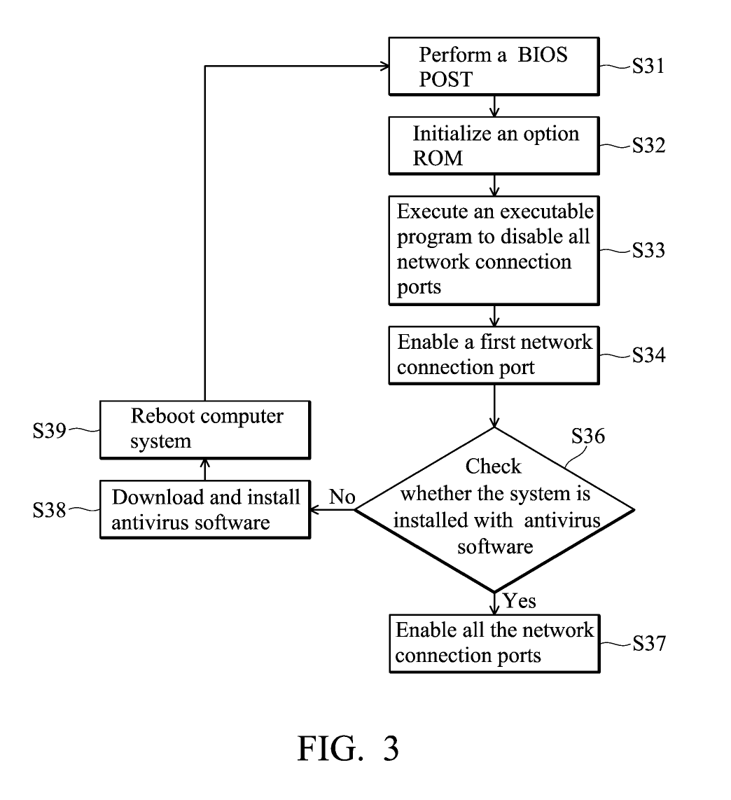

FIG. 3 is a flowchart of a method for antivirus protection of a computer according to another embodiment of the invention. After a computer is booted up, step S31 which is to perform a BIOS POST is performed. In step S32, an option ROM is initialized. The option ROM stores an executable file. In step S33, the computer executes the executable file to disable all network connection ports. In step S34, a predetermined first network connection port is enabled. Since all the network connection ports (except the predetermined first network connection port) are disabled, the risk of being infected by a virus under a network circumstance after booting process is greatly reduced. The computer receives and executes a detecting program via the predetermined first network connection port, and in step S36, the computer checks whether any antivirus software is installed on the computer. If the computer is installed with the antivirus software, step S37 is performed. That is, all the network connection ports are enabled. If the computer is not installed with any antivirus software, step S38 is performed. That is, the computer receives and is installed with second antivirus software via the first network connection port. After the second antivirus software is installed on the computer, step S39 is performed. That is, the computer is rebooted.

FIG. 4 is a schematic diagram of a system with antivirus protection of a computer according to an embodiment of the invention. The system with antivirus protection includes a computer 41 and a server 50. The computer 41 and the server 50 are connected with each other via network. The server 50 includes antivirus software 52 and a detecting program 51. The detecting program 51 is used to detect whether any antivirus software is installed on the computer 41. The computer 41 includes a BIOS 42, a CPU 43, a network module 46, a chipset 40, and a hard disk 48 storing an operating system 45. After the computer is booted up, the CPU 43 first executes the BIOS 42 and initializes the option ROM 44 after performing the BIOS POST. After initializing the option ROM, the CPU 43 executes the executable file stored in the option ROM 44, and it disables all network connection ports of the network module 46 by the chipset 40 and keeps only a predetermined first network connection port enabled. In the embodiment, the network module 46 may be an Ethernet module or a wireless network module.

Since the network connection ports (except the predetermined first network connection port) of the network module 46 are all disabled, the risk of being infected by a virus under a network circumstance after booting process is greatly reduced. Therefore, the CPU 43 may transmit a request signal to the server 50 to detect whether any antivirus software is installed on the computer 41 via the predetermined first network connection port. When the receiver 50 receives the request signal, it sends a detecting program 51 to the computer 41. The CPU 43 executes the detecting program to check whether any antivirus software is installed on the computer 41. If it is detected that the computer 41 is installed with antivirus software, the CPU 43 enables all the disabled network connection ports of the network module 46 by the chipset 40. Afterwards, the control of the computer 41 is transferred to the operating system 45. If it is detected that the computer 41 is not installed with any antivirus software, the CPU 43 transmits another request signal to the server 50. After receiving the request signal, the server 50 sends antivirus software 52 to the computer 41 to be installed. In another embodiment, the server 50 may first send an installation program to the computer 41. When the computer 41 receives the installation program, the CPU 43 downloads the antivirus software via the predetermined first network connection port by executing the installation program and the antivirus software 52 is installed. After the antivirus software 52 is installed, the computer is rebooted and the above actions are performed repeatedly.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for antivirus protection, adapted for an electronic device, the method comprising the steps of:
initializing an option read only memory (ROM);
disabling all network connection ports of the electronic device;
enabling a first network connection port to connect the electronic device with an external system;
checking whether first antivirus software is installed on the electronic device; and
if the first antivirus software is not installed on the electronic device, receiving and installing second antivirus software of the external system on the electronic device via the first network connection port.

2. The method for antivirus protection according to claim 1, wherein the step of blocking all the network connection ports of the electronic device comprises the step of:
executing an executable file of the option ROM to block all the network connection ports of the electronic device.

3. The method for antivirus protection according to claim 1, wherein the step of determining whether the first antivirus software is installed on the electronic device comprises the step of:
receiving a detecting program via the first network connection port to check whether the first antivirus software is installed on the electronic device.

4. The method for antivirus protection according to claim 1, further comprising the step of:
after finishing installing the second antivirus software on the electronic device, rebooting the electronic device.

5. The method for antivirus protection according to claim 1, further comprising the step of:
if the first antivirus software is installed on the electronic device, enabling all the network connection ports of the electronic device.

6. The method for antivirus protection according to claim 1, further comprising the step of performing a basic input output system (BIOS) power-on self test (POST) before all the network connection ports of the electronic device are blocked.

7. The method for antivirus protection according to claim 1, wherein the contents of the first antivirus software are the same with the contents of the second antivirus software.

8. An electronic device for downloading second antivirus software of an external system, the electronic device comprising:
a BIOS having an option ROM storing an executable file;
a chipset connected with the BIOS;
a network module, connected with the chipset, having a plurality of network connection ports; and
a central processing unit (CPU), connected with the chipset, for executing the executable file to disable the network connection ports and enable a first network connection port of the network connection ports to connect the electronic device with the external system, wherein when it is checked that first antivirus software is not installed on the electronic device, the second antivirus software is received and installed via the first network connection port.

9. The electronic device according to claim 8, wherein the step of it is checked that the first antivirus software is not installed on the electronic device by using the CPU receives a detecting program of the external system.

10. The electronic device according to claim 8, wherein after the first antivirus software is installed on the electronic device, the CPU controls the electronic device to reboot.

11. The electronic device according to claim 8, wherein if the first antivirus software is installed on the electronic device, all the network connection ports of the electronic device are unblocked.

12. The electronic device according to claim 8, wherein the network module is an Ethernet module or a wireless network module.
